(19) United States
(12) Patent Application Publication
(10) Pub. No.: US 2017/0086447 A1
(43) Pub. Date: Mar. 30, 2017

(54) CARBON DIOXIDE SOURCE FOR ARTHROPOD VECTOR SURVEILLANCE

(71) Applicant: The United States of America as Represented by the Secretary of the Army, Fort Detrick, MD (US)

(72) Inventor: PETER NUNN, (US)

(21) Appl. No.: 15/126,668

(22) PCT Filed: Sep. 14, 2015
(86) PCT No.: PCT/US2015/049900

§ 371 Date: Sep. 16, 2016

Related U.S. Application Data
(60) Provisional application No. 62/050,867, filed on Sep. 16, 2014.

(51) Int. Cl. A01M 1/02; A01M 1/04; A01M 1/10

(52) U.S. Cl. CPC A01M 1/023; A01M 1/106; A01M 1/103; A01M 1/04; C01B 31/20

(57) ABSTRACT

An arthropod trap (10) includes a source (60) of CO₂ gas. The CO₂ gas is released proximate the arthropod trap (10). The source (60) of the CO₂ gas includes an inflatable bladder (42) filled with breath (46) that was exhaled by a human being (100).

### STATEMENT OF GOVERNMENT INTEREST

The invention described herein may be manufactured, used and licensed by or for the United States Government.

### BACKGROUND OF THE INVENTION

The invention relates in general to surveillance of disease-transmitting vectors and in particular to surveillance of disease-transmitting arthropods.

Vector control is any method to limit or eradicate the mammals, birds, insects or other arthropods that transmit disease pathogens. The most frequent type of vector control is directed to mosquitos and other arthropods. These vectors are able to find a human host by picking up the scent of the human being and by detecting carbon dioxide emitted from a human. Vector surveillance determines the presence and identity of vectors. The goal of vector surveillance is to effectively lure vectors to a trap and collect them for purposes of identification of the vector and the disease threat. Then, appropriate prevention and control methods can be implemented to protect personnel from vector-borne diseases. Surveillance provides data (species and number of each important vector in an area) used for risk analysis and mitigation planning to protect personnel from vector-borne diseases.

Known light traps are not effective in collecting vectors of diseases like malaria, dengue and leishmaniasis, particularly if the trap has no lure other than light to attract mosquitoes and other biting arthropods. One of the best mosquito lures is a human being, but it is unethical to use a human being as bait for vector surveillance. The next best lure is carbon dioxide in the form of dry ice or compressed gas from a cylinder. Both dry ice and compressed carbon dioxide gas can be difficult to obtain in some areas, particularly in remote locations. When they are available, they are costly. In addition, compressed gas cylinders may be prohibited on transport platforms such as helicopters and fixed wing aircraft. Dry ice and compressed gas cylinders are bulky, heavy and often require resupply, thereby complicating vector surveillance.

A need exists for a smaller, lighter weight, cheaper, more easily transportable source of carbon dioxide for vector surveillance.

### SUMMARY OF THE INVENTION

One aspect of the invention is an apparatus that includes an arthropod trap and a source of CO₂ gas having an outlet for exhausting the CO₂ gas. The outlet is disposed proximate the arthropod trap. The source of CO₂ gas includes an inflatable bladder filled with breath that was exhaled by a human.

The apparatus may include an open/close valve connected to the inflatable bladder and a fluid conduit connected to the open/close valve. A regulator valve may be disposed in the fluid conduit. The fluid conduit may include the outlet.

Another aspect of the invention is a method of luring arthropods to an arthropod trap. The method includes providing an arthropod trap and filling a container with breath that was exhaled by a mammal. The exhaled breath in the container is then released near the arthropod trap in a controlled manner

A further aspect of the invention is an apparatus that includes an arthropod trap and a container filled with breath exhaled from a human being. A fluid conduit has one end fixed to an outlet of the container and an open end disposed proximate the arthropod trap. A valve is disposed in the fluid conduit for controlling the flow of the exhaled breath from the container to the open end of the fluid conduit.

Another aspect of the invention is an apparatus that includes an arthropod trap and a flexible bladder containing CO₂ gas. A fluid conduit has one end fixed to an outlet of the flexible bladder and an open end disposed proximate the arthropod trap. A valve is disposed in the fluid conduit for controlling the flow of the exhaled breath from the flexible bladder to the open end of the fluid conduit.

An additional aspect of the invention is a kit for supplying CO₂ gas to an arthropod trap. The kit includes at least one flexible bladder and a length of rigid conduit having an open/close valve. The length of rigid conduit has one end configured to receive the at least one flexible bladder. The kit includes a length of flexible conduit having a regulating valve. The length of flexible conduit has one end configured for attachment to the length of rigid conduit.

### BRIEF DESCRIPTION OF THE DRAWINGS

In the drawings, which are not necessarily to scale, like or corresponding parts are denoted by like or corresponding reference numerals.

FIG. 1 is a schematic of an arthropod trap.

FIG. 2 is a schematic of one embodiment of an apparatus for supplying CO₂ gas to an arthropod trap.

FIG. 3 is a schematic view of one way to fix a bladder to a fluid conduit.

FIG. 4 is an exploded schematic view of another embodiment of an apparatus for supplying CO₂ gas to an arthropod trap.

FIG. 5 is a schematic view of a further embodiment of an apparatus for supplying CO₂ gas to an arthropod trap.

FIG. 6 is a schematic view of a compressed gas cylinder for holding CO₂ gas.

FIG. 7 is a schematic view of a dry ice (CO₂) pellet.

FIG. 8 is a view of a human being.

FIG. 9 is a graph of parts per million of CO₂ gas versus time.

FIG. 10 is a bar graph that compares the performance of an embodiment of the invention to dry ice and to a control, in a screened enclosure.

FIG. 11 is a bar graph that compares the performance of an embodiment of the invention to dry ice and to a control, in a swampy area.

FIG. 12 is a bar graph that compares the performance of an embodiment of the invention to dry ice and to a control, in a woody area.

FIG. 13 is a bar graph that compares the performance of an embodiment of the invention to a control, in the swampy and woody areas.

### DETAILED DESCRIPTION

A novel source of carbon dioxide gas for an arthropod trap is useful for pest and disease surveillance of insect and other arthropod vectors. The novel CO₂ gas source may be used wherever surveillance is conducted. The disclosed apparatus and method may be used with a wide variety of arthropod traps, for example, the CDC (Centers for Disease Control) light trap, BG-Sentinel (Biogent) trap, and other types and varieties of arthropod traps. For example, the invention may be used with arthropod traps that do not include a light or other lure sources. An example of a CDC light trap is shown at http://johnwhock.com/products/mosquito-sandfly-traps/cdc-miniature-light-trap/ (last accessed on Aug. 18, 2015). An example of a BG-Sentinel (Biogent) trap is shown at http://www.bg-sentinel.com (last accessed on Aug. 18, 2015).

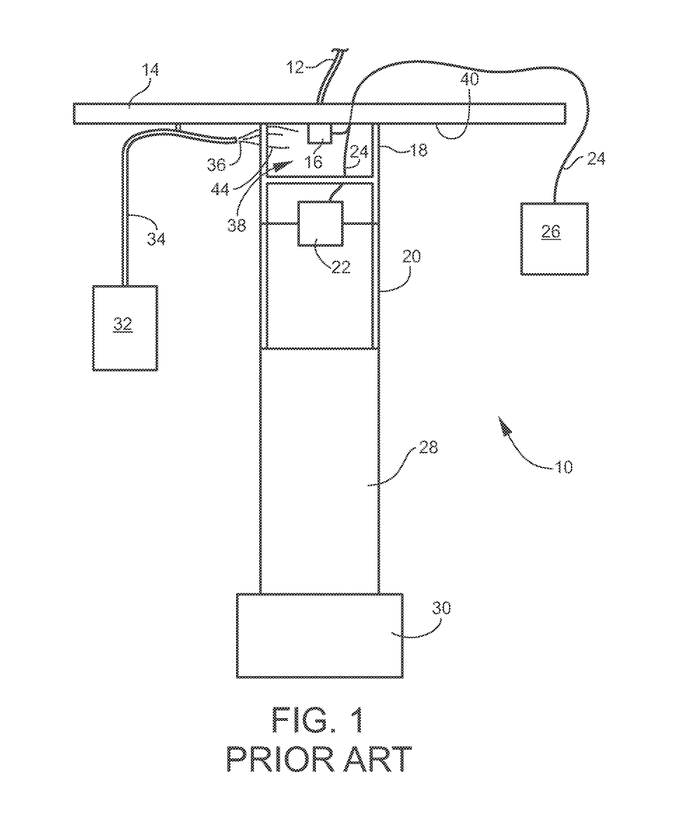

FIG. 1 is a schematic drawing of a known trap 10 for trapping mosquitos. Trap 10 is only one example of an arthropod trap. Many other types of arthropod traps may be used to practice the invention. Trap 10 may be suspended above the ground using, for example, a rope or plastic cord 12. Trap 10 may include a rain guard in the form of a circular disc 14. Disc 14 may include a light bulb 16 mounted therein. A bracket 18 for holding a cylindrical support 20 is fixed to an underside of disc 14. Bracket 18 or support 20 may also support a fan 22. Electric power for bulb 16 and fan 22 may be supplied via a power cord 24 connected to a battery source 26. A mesh collecting bag 28 is fixed at one end to cylindrical support 20 and at another end to a collection container 30. The materials of construction and manner of making a trap such as trap 10 are well-known.

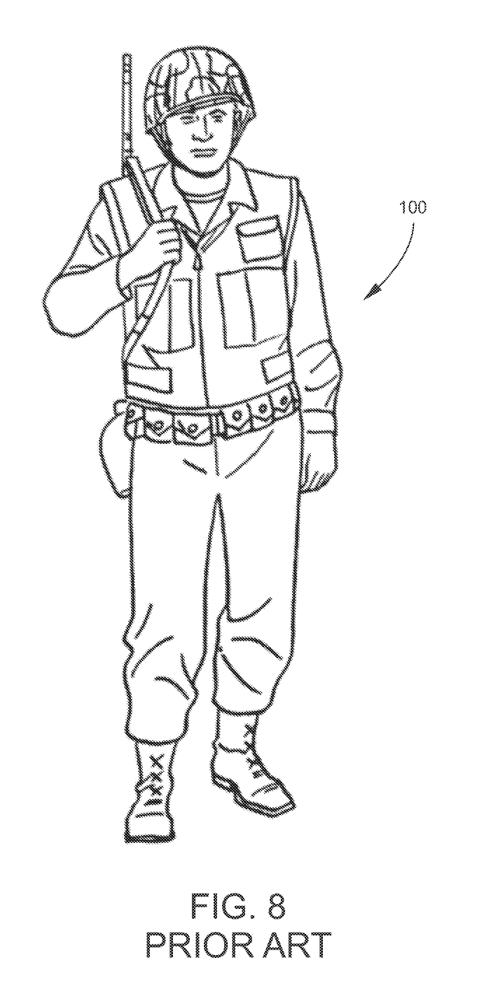

To improve the attractiveness of trap 10 to mosquitos, a source 32 of CO₂ gas is connected to a tube 34. The outlet 36 of tube 34 is placed at an area near trap 10, such as the intake area 38 of fan 22 or on the bottom surface 40 of disc 14. The CO₂ gas 44 flowing from outlet 36 can greatly enhance the effectiveness of trap 10. In the prior art, the source 32 of CO₂ gas was, for example, a thermal cooler containing dry ice pellets 98 (FIG. 7) or a rigid pressure vessel 96 (FIG. 6) containing high pressure, compressed CO₂ gas.

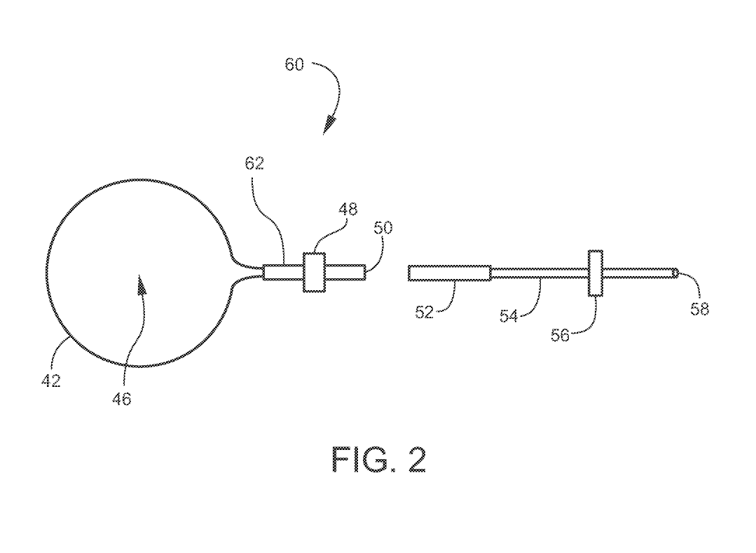

FIG. 2 is a schematic of one embodiment of an apparatus 60 for supplying exhaled breath containing CO₂ gas to an arthropod trap, for example, trap 10. Apparatus 60 includes an inflatable bladder 42, such as a balloon. The capacity of bladder 42 may vary, for example, from a fraction of a cubic foot to 35 cubic feet or more. Bladder 42 is connected to a conduit 62 having an open/close valve 48. Bladder 42 is fluidly sealed to one end of conduit 62. One way to seal bladder 42 to conduit 62 is with rubber bands. Another end 50 of the conduit 62 is open. Bladder 42 is inflated by, for example, a human being 100 (FIG. 8). The human being 100 repeatedly exhales into open end 50 of the conduit 62 when valve 48 is in an open position. When bladder 42 is full of exhaled air 46, valve 48 is closed and open end 50 is connected to a second conduit 52. A reduced diameter conduit 54 may be fixed to the larger diameter conduit 52. A regulator valve 56 is disposed in the conduit 54. Conduits 62, 52 and 54 may be made of, for example, PVC, rubber, etc.

The outlet 58 of conduit 54 is placed proximate to a trap 10, in a manner known in the art. For example, outlet 58 may be placed proximate trap 10 in a manner similar to outlet 36 in FIG. 1. The regulator valve 56 is adjusted so that a desired flow rate of exhaled air 46 flows from outlet 58 in a controlled manner The exhaled air 46 contains CO₂ gas and human scent. Both the CO₂ gas and the human scent are powerful attractants for some arthropods.

The earth's atmosphere is about 0.0397% CO₂ gas. Exhaled human breath is about 5% CO₂ gas. One exhale of human breath is about 500 ml or 0.01765 cubic feet of CO₂ gas. Tests have shown that the exhaled air 46, although lower in CO₂ content than some prior art CO₂ gas sources, is effective in attracting arthropods. The presence of the human scent in the exhaled air 46 may be a factor that increases its effectiveness. In very remote areas where no other source of CO₂ gas is readily available, the apparatus 60 provides an effective CO₂ gas source that is inexpensive and easily transported and used.

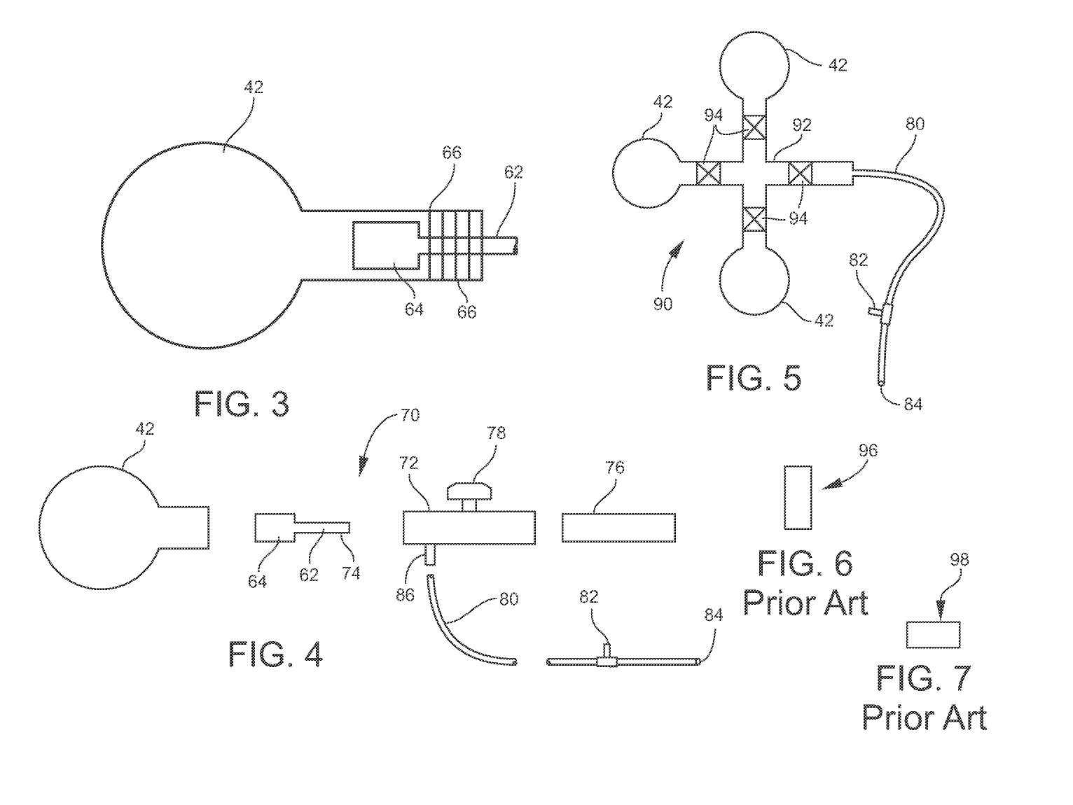

FIG. 3 is a schematic view of one way to fix a bladder 42 to a conduit 62. Conduit 62 may include an enlarged portion 64. Bladder 42 may be fixed to conduit 62 using, for example, one or more rubber bands 66.

Multiple bladders 42 may be used with a trap 10, either separately or fluidly connected in series or parallel. When fully filled with air exhaled by a human being 100, bladder 42 preferably has a diameter of at least about three feet, although smaller and larger bladders may be used. When multiple bladders are used, check valves are preferably positioned at each bladder 42 to ensure the exhaled air does not flow from one bladder into another bladder. A bladder 42 with a diameter of about three feet has a capacity of about 14 cubic feet. Bladder 42 may be inflated somewhat less than its full capacity to help eliminate accidental punctures in bladder 42. Bladder 42 may be made of a variety of known materials used for balloons and inflatable bladders.

FIG. 4 is a schematic exploded view of another apparatus 70 for supplying exhaled breath containing CO₂ gas to an arthropod trap, for example, trap 10. Apparatus 70 includes an inflatable bladder 42 fixed to an enlarged end 64 of conduit 62. An end 74 of conduit 62 fits inside conduit 72. Another conduit 76 may fit into the other end of conduit 72 and may be used as a mouthpiece to inflate bladder 42. A valve 78 is opened when inflating bladder 42 via mouthpiece 76. A flexible tube 80 may be fixed to an outlet nipple 86 on conduit 72. The end 84 of tube 80 is placed adjacent to trap 10 in a known manner Valve 82 is opened so that exhaled air in bladder 42 may flow through tube 80 and out end 84. The extent to which valve 82 is opened determines the flow rate of the exhaled air that is released adjacent to trap 10.

FIG. 5 is a schematic view of an embodiment of an apparatus 90 for supplying exhaled air from a human being 100 to an arthropod trap such as trap 10. Apparatus 90 includes three bladders 42 each connected to a four-way fitting 92 having a valve 94 in each arm. A flexible tube 80 is fluidly connected to one arm of fitting 90. Valves 94 are opened so that exhaled air that is contained in each bladder 42 may flow through tube 80. Valve 82 in tube 80 is used to regulate the flow out of end 84 of tube 80.

Apparatus 60, 70 and 90 may also be used with conventional CO₂ sources, although exhaled human breath is the preferred gas for inflating bladder 42. For example, one may desire to deploy multiple arthropod traps, but there may be only one or a few CO₂ compressed gas cylinders or dry ice coolers. In this case, the CO₂ gas from the gas cylinders or dry ice coolers may be used to fill bladders 42 of multiple apparatus 60, 70 or 80.

### Test Results

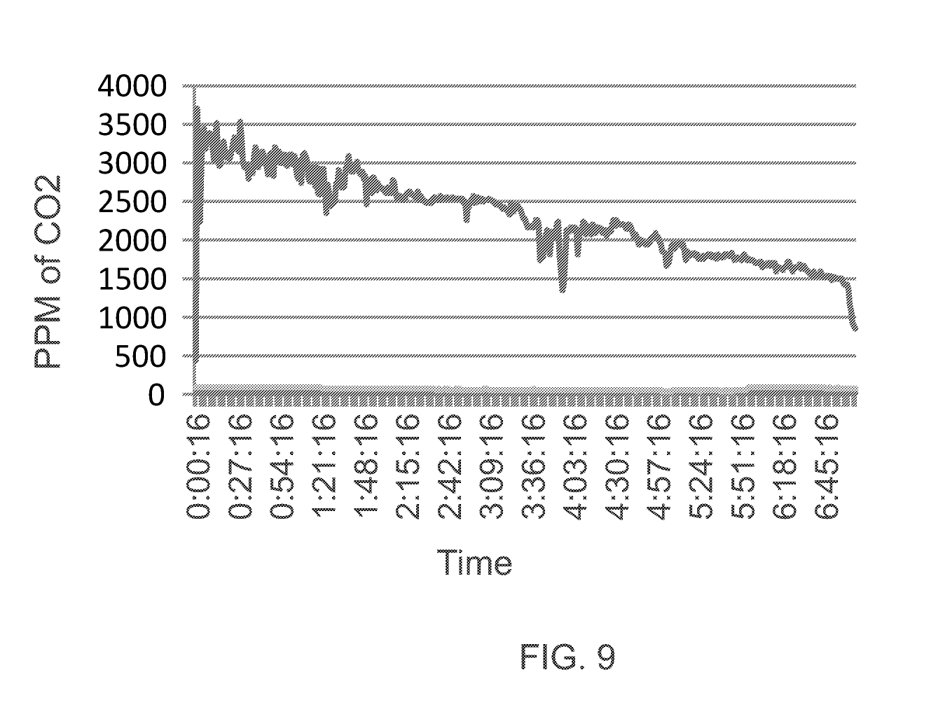

FIG. 9 is a graph of parts per million of CO₂ gas versus time. FIG. 9 was created by measuring the parts per million of CO₂ gas with a gas meter located about one foot from the exit end 84 of an apparatus similar to apparatus 70 (FIG. 4). The bladder 42 was inflated with exhaled human breath to a diameter of about three feet and then the valve 82 opened an amount so that CO₂ gas would flow for about seven hours.

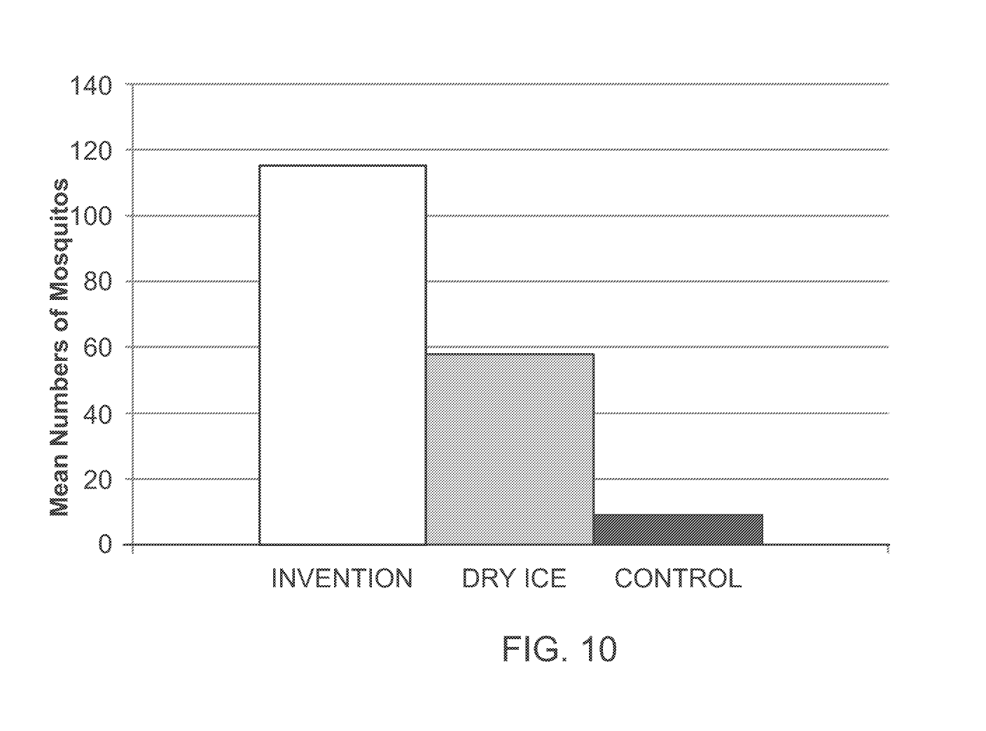

FIG. 10 is a bar graph comparing the performance of an embodiment of the invention with dry ice and a control. The test comparisons were made in a large screened enclosure over an eight day period. Each day a new test was conducted. Three test devices were used. One device was an embodiment of the invention similar to apparatus 70 (FIG. 4) in conjunction with a CDC trap. The bladder 42 in apparatus 70 was filled with exhaled breath from a human. A second device was a CDC trap in conjunction with dry ice pellets as a CO₂ gas source. The third device was a CDC trap with no CO₂ source. The third device functioned as a test control.

Each day at 8 AM two hundred mosquitos (Aedes aegyti) were released into the screened enclosure containing the three test devices. After four hours, the three devices were removed and the numbers of mosquitos captured by each device were counted. FIG. 10 shows the average number of mosquitos captured per day by each device over the eight day period. The CDC trap with the embodiment of the invention substantially outperformed (captured more mosquitos) the CDC trap with dry ice and the control device (CDC trap with no carbon dioxide source).

Further tests were conducted in open areas, specifically a swampy area and a forested or woody area. CDC traps were used in conjunction with an embodiment of the invention (similar to apparatus 70 in FIG. 4) as a source of carbon dioxide, with dry ice as a source of carbon dioxide and with no source of carbon dioxide (test control). Traps were left out in the open areas for about 21 hours and then collected and the mosquitos caught by each trap tallied.

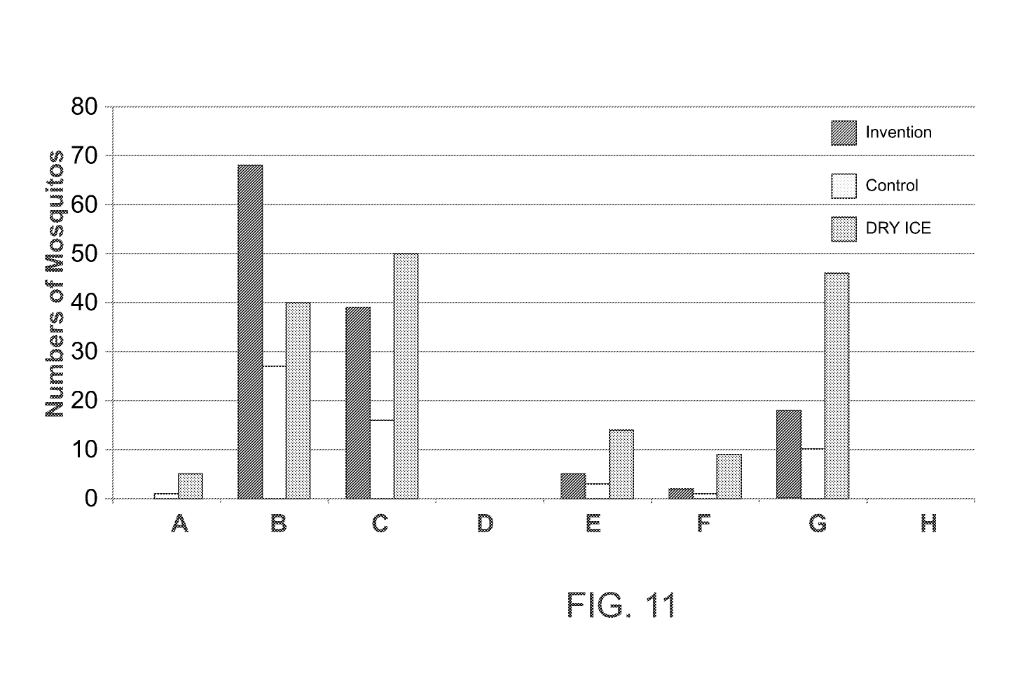

FIG. 11 is a bar graph of the numbers of medically important mosquitos caught at the swampy area by each of the three CDC traps. The letters A-H on the x-axis of FIG. 11 correspond to the following mosquitos: A-Aedes albopictus; B-Anopheles crucians; C-Anopheles quadrimaculatus; D-Culiseta melanura; E-Culex nigripalpus; F-Culex quinquefasciatus; G-Aedes vexans; and H-Aedes infirmatus.

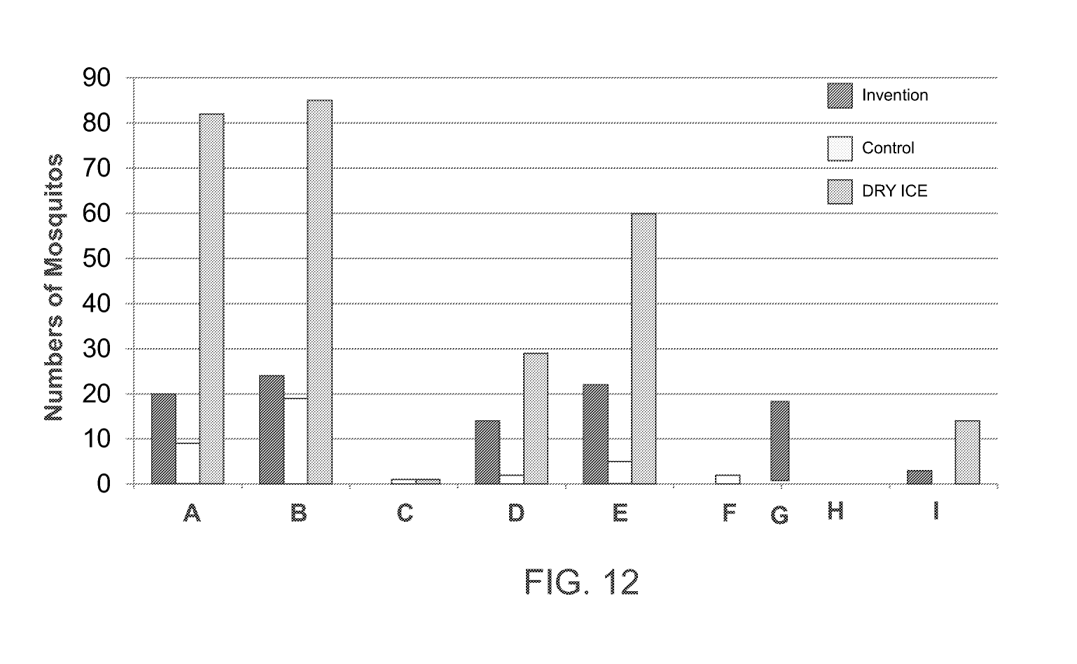

FIG. 12 is a bar graph of the number of medically important mosquitos caught at the forested area by each of the three CDC traps. The letters A-I on the x-axis of FIG. 12 correspond to the following mosquitos: A-Aedes albopictus; B-Anopheles crucians; C-Anopheles quadrimaculatus; D-Culiseta melanura; E-Culex nigripalpus; F-Culex quinquefasciatus; G-Coquillettidia perturbans; H-Aedes vexans; and I-Aedes infirmatus.

In FIGS. 11 and 12, the CDC trap with the dry ice appears to be superior in some cases to the CDC trap with the embodiment of the invention. However, during the 21 hour test period, the dry ice was not completely used up and, therefore, supplied a constant source of carbon dioxide to its CDC trap. On the other hand, the embodiment of the invention supplied carbon dioxide to its CDC trap for only about 7 hours. Thus, the time span during which carbon dioxide was present at the CDC trap with the invention is about one third of the time span during which carbon dioxide was present at the CDC trap with dry ice.

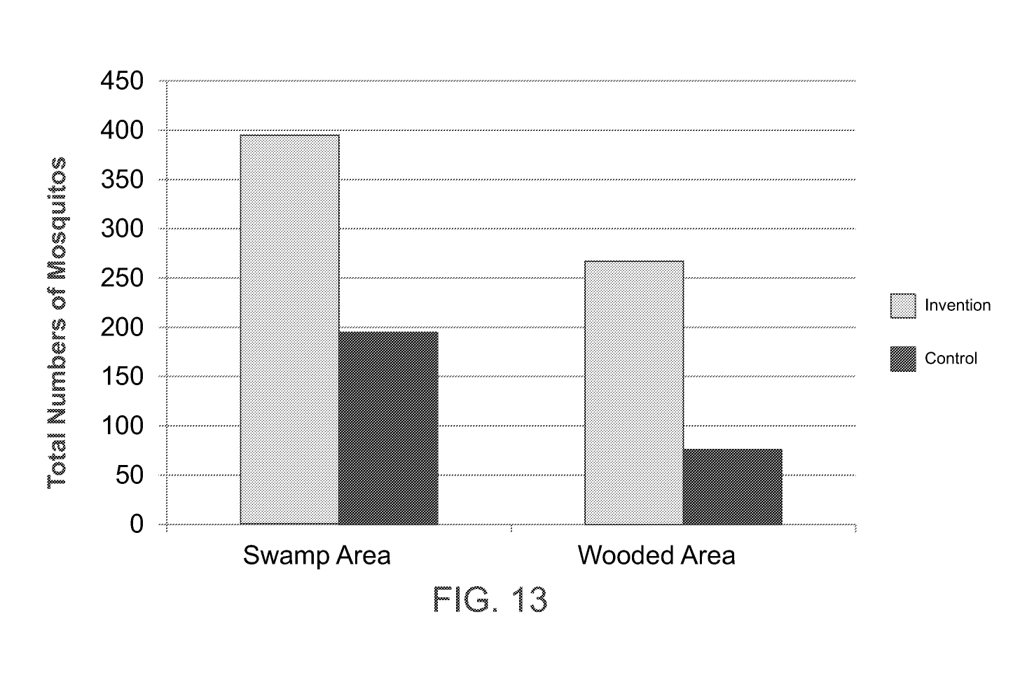

FIG. 13 is a bar graph of the number of all mosquitos caught at the swamp area and the forested area by the CDC trap with an embodiment of the invention as a source of carbon dioxide and a CDC trap with no carbon dioxide source (control).

As seen in FIG. 13, the CDC trap with an embodiment of the invention as a carbon dioxide source is more effective than a CDC trap without a carbon dioxide source.

Many changes in the details, materials, steps and arrangement of parts described herein may be made by those skilled in the art within the principle and scope of the invention, as expressed in the appended claims. For example, the bladders, conduits, tubing, valves and other components of apparatus 60, 70 and 90 may be arranged in a variety of configurations that enable exhaled human breath or pure or diluted CO₂ gas to be stored and then released adjacent to an arthropod trap. The exhaled breath may also be obtained from a primate or, more generally, from a mammal

1. An apparatus, comprising:
an arthropod trap; and
a source of CO₂ gas including an outlet for exhausting the CO₂ gas, the outlet being disposed proximate the arthropod trap;
wherein the source of CO₂ gas includes an inflatable bladder filled with breath that was exhaled by a mammal.

2. The apparatus of claim 1, wherein the mammal is a primate.

3. The apparatus of claim 2, wherein the primate is a human being.

4. The apparatus of claim 3, further comprising an open/close valve connected to the inflatable bladder and a fluid conduit connected to the open/close valve.

5. The apparatus of claim 4, further comprising a regulator valve in the fluid conduit.

6. The apparatus of claim 5, wherein the fluid conduit includes the outlet.

7. A method of luring arthropods to an arthropod trap, comprising:
providing the arthropod trap;
filling a container with breath exhaled by a mammal; and
releasing the breath in the container near the arthropod trap in a controlled manner.

8. The method of claim 7, wherein releasing includes releasing the breath through a fluid conduit having a regulator valve.

9. The method of claim 7, wherein filling a container includes filling a container with breath exhaled by a primate.

10. The method of claim 9, wherein filling a container includes filling a container with breath exhaled by a human being.

11. An apparatus, comprising:
an arthropod trap;
a container filled with breath exhaled from a human being;
a fluid conduit having one end fixed to an outlet of the container and an open end disposed proximate the arthropod trap; and
a valve disposed in the fluid conduit for controlling the flow of the exhaled breath from the container to the open end of the fluid conduit.

12. The apparatus of claim 11, wherein the container is a flexible bladder.

13. An apparatus, comprising:
an arthropod trap;
a flexible bladder containing CO₂ gas;
a fluid conduit having one end fixed to an outlet of the flexible bladder and an open end disposed proximate the arthropod trap; and
a valve disposed in the fluid conduit for controlling the flow of the CO₂ gas from the flexible bladder to the open end of the fluid conduit;
wherein the flexible bladder contains breath exhaled from a human being and the CO₂ gas is a component of the exhaled breath.

14. (canceled)

15. A method, comprising:
providing the apparatus of claim 13; and
at least partially filling the flexible bladder with the CO₂ gas wherein at least partially filling includes at least partially filling the flexible bladder with the CO₂ gas obtained from breath exhaled from a human being.

16. (canceled)

17. (canceled)

18. (canceled)

19. (canceled)

20. (canceled)
